(19) United States
(12) Patent Application Publication
(10) Pub. No.: US 2020/0247956 A1
(43) Pub. Date: Aug. 6, 2020

(54) METHOD OF PRODUCING POLYARYLENE SULFIDE

(71) Applicant: Kureha Corporation, Tokyo (JP)

(72) Inventors: Takeshi SATO, Tokyo (JP); Ken-ichi TAKAKI, Tokyo (JP); Yoshinori SUZUKI, Tokyo (JP)

(73) Assignee: Kureha Corporation, Tokyo (JP)

(21) Appl. No.: 16/639,663

(22) PCT Filed: Oct. 9, 2018
(86) PCT No.: PCT/JP2018/037553

§ 371 Date: Feb. 17, 2020

(30) Foreign Application Priority Data
Oct. 10, 2017 (JP) 2017-196779

(51) Int. Cl. C08G 75/0259; C08G 75/0277

(52) U.S. Cl. CPC C08G 75/0259; C08G 75/0277

(57) ABSTRACT

A method of producing a PAS, which is the method capable of providing a PAS having a high melt viscosity in high yield in a shorter polymerization time, is provided. The method including: a preparation step; a first polymerization step; and subsequently a second polymerization step for continuing to perform a polymerization reaction by adding to the reaction mixture from 0.09 to 0.2 mol of an additional alkali metal hydroxide relative to 1 mol of the sulfur source. In the first polymerization step, the polymerization reaction is performed on condition that a pH of the reaction mixture is 11 or higher until a conversion ratio of the dihalo aromatic compound being 50 mol % or greater.

### TECHNICAL FIELD

The present invention relates to a method of producing a polyarylene sulfide.

### BACKGROUND ART

A polyarylene sulfide (hereinafter, also referred to as “PAS”), represented by polyphenylene sulfide (hereinafter, also referred to as “PPS”), is an engineering plastic having excellent heat resistance, chemical resistance, flame retardancy, mechanical strength, electrical characteristics, dimensional stability, and the like. A PAS is used in a wide variety of technical fields including electrical instruments, electronic instruments, automobile instruments, and packaging materials, because a PAS can be formed into various molded products, films, sheets, and fibers by general melting processing methods such as extrusion molding, injection molding and compression molding.

An example of a method of producing a PAS includes a method of producing the PAS by polymerizing a sulfur source and a dihalo aromatic compound in an organic amide solvent (e.g., Patent Documents 1 and 2).

Prior Art Documents

### PATENT LITERATURE

Patent Document 1: JP 2014-47218 A

Patent Document 2: WO 2006/046748

### SUMMARY OF INVENTION

### Technical Problem

Among PASs, a PAS having a high melt viscosity has useful properties such as high toughness, and thus, for example, it has been suitably used as a metal substitute in the fields related to automobiles. Although it is desired to obtain a PAS having a high melt viscosity in high productivity, known production methods require a long polymerization time to increase the melt viscosity of the PAS, and thus the enhancement of productivity is limited.

The present invention was completed in light of the problem described above, and an object of the present invention is to provide a method of producing a PAS having a high melt viscosity in high yield in a shorter polymerization time.

### Solution to Problem

The present inventors conducted diligent research to achieve the object described above. Typically, as a method of producing a PAS in high yield suppressing side reactions, for example, a technique in which, at the stage of preparing raw materials, preparing less than an equimolar amount of an alkali metal hydroxide relative to a sulfur source is known. According to the study of the present inventors, it was found that a PAS having a high melt viscosity was not obtained when a polymerization reaction was performed for a relatively long time by using this technique to obtain a PAS having a high melt viscosity. As a result of detailed analysis of the polymerization reaction, the present inventors discovered that, as the polymerization reaction proceeded, the pH of the reaction mixture was significantly dropped, causing side reactions that hinder the molecular chain to grow, and thus a PAS having a high melt viscosity was not obtained. When the pH of the reaction mixture is less than 11, the molecular chain is particularly less likely to be elongated. The present inventors shortened the time for the preceding polymerization and then transitioned to the subsequent polymerization while the pH was 11 or more, and continued the polymerization reaction. Surprisingly, in this method the present inventors found that a PAS having a high melt viscosity was obtained in high yield although the polymerization time was even shorter.

Based on the findings described above, the present inventors discovered that the above object can be achieved by, in a first polymerization step that performs a polymerization reaction by heating a prepared mixture containing less than the equimolar amount of the alkali metal hydroxide relative to a sulfur source, performing a polymerization reaction on condition that the pH of a reaction mixture is 11 or higher until a conversion ratio of a dihalo aromatic compound reaches 50 mol % or greater, and thus completed the present invention.

The method of producing a PAS according to an embodiment of the present invention is a method to produce a PAS by polymerizing a sulfur source and a dihalo aromatic compound in an organic polar solvent,

the method including:

a preparation step for preparing a mixture containing an organic polar solvent, a sulfur source, water, a dihalo aromatic compound, and an alkali metal hydroxide,

a first polymerization step for performing a polymerization reaction by heating the mixture to produce a reaction mixture containing a prepolymer, and

a second polymerization step for continuing to perform a polymerization reaction subsequent to the first polymerization by adding an additional alkali metal hydroxide to the reaction mixture; and

in the preparation step, an amount of the alkali metal hydroxide is less than an equimolar amount relative to the sulfur source;

in the first polymerization step, the polymerization reaction is performed until a conversion ratio of the dihalo aromatic compound reaches 50 mol % or greater on condition that a pH of the reaction mixture is 11 or higher; and

in the second polymerization step, an amount of the additional alkali metal hydroxide is from 0.09 mol to 0.2 mol relative to 1 mol of the sulfur source.

A melt viscosity of the polyarylene sulfide measured at a temperature of 310° C. and a shear rate of 1216 sec⁻¹ is preferably from 1 to 3000 Pa·s.

In the preparation step, the amount of the alkali metal hydroxide is preferably 0.75 mol or more and less than 1 mol relative to 1 mol of the sulfur source.

### ADVANTAGEOUS EFFECTS OF INVENTION

According to an embodiment of the present invention, a method that can produce a PAS having a high melt viscosity in high yield in a shorter polymerization time can be provided. Generally, in the first polymerization step, increasing the conversion ratio of the dihalo aromatic compound can increase a molecular weight of the prepolymer, and as a result, a PAS having a high melt viscosity can be produced. Therefore, when the time for the first polymerization step is shortened like an embodiment of the present invention, since the conversion ratio becomes less, it is predicted that a PAS having a high melt viscosity is less likely to be obtained. However, contrary to such a prediction, an embodiment of the present invention achieves an enhancement of the melt viscosity of the PAS even when the time for the first polymerization step is shortened. As described above, an embodiment of the present invention achieves an effect that would not have been easily predicted based on the previously known technologies.

### DESCRIPTION OF EMBODIMENTS

An embodiment of the method of producing PAS according to the present invention is described hereinafter. The method of producing a PAS according to the present embodiment includes, as essential steps, a preparation step, a first polymerization step, and a second polymerization step. Furthermore, the method of producing a PAS according to the present embodiment may optionally include a dehydration step, a cooling step, and a post-treatment step, for example. Each of the materials used in an embodiment of the present invention is described in detail below, and each step is also described in detail below.

Organic polar solvent, sulfur source, dihalo aromatic compound, and alkali metal hydroxide

As an organic polar solvent, a sulfur source, a dihalo aromatic compound, and an alkali metal hydroxide, those typically used in production of a PAS can be used. The organic polar solvent, the sulfur source, the dihalo aromatic compound, and the alkali metal hydroxide may each be used alone or may be used as a mixture of two or more of each kind as long as the combination can produce the PAS.

Examples of the organic polar solvent include organic amide solvents; aprotic organic polar solvents formed from organosulfur compounds; and aprotic organic polar solvents formed from cyclic organophosphorus compounds. Examples of the organic amide solvent include amide compounds, such as N,N-dimethylformamide and N,N-dimethylacetamide; N-alkylcaprolactam compounds, such as N-methyl-ε-caprolactam; N-alkylpyrrolidone compounds or N-cycloalkylpyrrolidone compounds, such as N-methyl-2-pyrrolidone (hereinafter, also referred to as “NMP”) and N-cyclohexyl-2-pyrrolidone; N,N-dialkylimidazolidinone compounds, such as 1,3-dialkyl-2-imidazolidinone; tetraalkyl urea compounds, such as tetramethyl urea; and hexaalkylphosphate triamide compounds, such as hexamethyl phosphate triamide. Examples of the aprotic organic polar solvent formed from an organosulfur compound include dimethyl sulfoxide and diphenyl sulfone. Examples of the aprotic organic polar solvent formed from a cyclic organophosphorus compound include 1-methyl-1-oxophosphorane. Among these, from the perspectives of availability and ease of handling, organic amide solvents are preferred; N-alkyl pyrrolidone compounds, N-cycloalkyl pyrrolidone compounds, N-alkyl caprolactam compounds, and N,N-dialkyl imidazolidinone compounds are more preferred; NMP, N-methyl-ε-caprolactam, and 1,3-dialkyl-2-imidazolidinone are even more preferred; and NMP is particularly preferred.

Examples of the sulfur source include alkali metal sulfides, alkali metal hydrosulfides, and hydrogen sulfides, and alkali metal sulfides and alkali metal hydrosulfides are preferred. The sulfur source can be handled, for example, in a state of an aqueous slurry or an aqueous solution, and is preferably in a state of an aqueous solution from the perspective of handleability such as measurability and transportability. Examples of the alkali metal sulfides include lithium sulfide, sodium sulfide, potassium sulfide, rubidium sulfide, and cesium sulfide. Examples of the alkali metal hydrosulfides include lithium hydrosulfide, sodium hydrosulfide, potassium hydrosulfide, rubidium hydrosulfide, and cesium hydrosulfide.

Examples of the dihalo aromatic compounds include o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide, and dihalodiphenyl ketone. A halogen atom is each an atom of fluorine, chlorine, bromine, and iodine, and the two halogen atoms in the dihalo aromatic compound may be the same or different. Among these, from the perspectives of availability and reactivity, p-dihalobenzene, m-dihalobenzene, and a mixture of these are preferred, p-dihalobenzene is more preferred, and p-dichlorobenzene (hereinafter, also referred to as “pDCB”) is particularly preferred.

Examples of the alkali metal hydroxide include lithium hydroxide, sodium hydroxide, potassium hydroxide, rubidium hydroxide, and cesium hydroxide.

### Dehydration Step

The dehydration step is a step of discharging at least a part of distillate containing water from a system, containing a mixture of an organic polar solvent, a sulfur source, and an alkali metal hydroxide, to outside the system, before the preparation step. The polymerization reaction of the sulfur source and the dihalo aromatic compound is affected, e.g., promoted or inhibited, by the amount of water present in the polymerization reaction system. Therefore, the water content of the polymerization reaction system is preferably reduced by performing the dehydration treatment before the polymerization so that the water content does not inhibit the polymerization reaction.

In the dehydration step, the dehydration is preferably performed by heating in an inert gas atmosphere. Water to be dehydrated in the dehydration step includes water contained in the raw materials charged in the dehydration step, an aqueous medium of the aqueous mixture, and water produced by a side reaction between the raw materials.

The heating temperature in the dehydration step is not particularly limited as long as the heating temperature is 300° C. or less but is preferably from 100 to 250° C. The heating time is preferably from 15 minutes to 24 hours, and more preferably from 30 minutes to 10 hours.

In the dehydration step, the dehydration is performed until the water content reaches a predetermined range. That is, in the dehydration step, it is preferable to perform the dehydration until the water content is preferably from 0.5 to 2.4 mol with respect to 1.0 mol of sulfur source (hereinafter, also referred to as “prepared sulfur source” or “effective sulfur source”) in a prepared mixture (described later). When the water content is too small in the dehydration step, the water content needs to be adjusted to a desired content by adding water in the preparation step performed before the polymerization step.

### Preparation Step

The preparation step is a step that prepares a mixture containing an organic polar solvent, a sulfur source, water, a dihalo aromatic compound, and an alkali metal hydroxide. The mixture prepared in the preparation step is also referred to as “prepared mixture”.

In the case where the dehydration step is performed, the amount of the sulfur source in the prepared mixture (hereinafter, also referred to as “amount of charged sulfur source” or “amount of effective sulfur source”) can be calculated by subtracting the molar quantity of the hydrogen sulfide volatilized in the dehydration step from the molar quantity of the sulfur source charged as the raw material.

In the preparation step, the amount of the alkali metal hydroxide is less than an equimolar amount relative to the charged sulfur source, is preferably 0.75 mol or more and less than 1 mol, more preferably from 0.75 to 0.99 mol, and even more preferably from 0.85 to 0.99 mol, or may be optionally from 0.85 to 0.98 mol, relative to 1 mol of the charged sulfur source. When the amount of the alkali metal hydroxide is less than an equimolar amount relative to the charged sulfur source in the preparation step, generation of byproducts during polymerization reaction tends to be suppressed, the nitrogen content derived from impurities in the produced PAS tends to be made sufficiently small, and the yield of the PAS tends to be sufficiently enhanced. Furthermore, a combination of allowing the amount of the alkali metal hydroxide to be less than an equimolar amount relative to the charged sulfur source in the preparation step and performing the polymerization reaction until a conversion ratio of the dihalo aromatic compound becomes 50 mol % or greater on condition that the pH of a reaction mixture is 11 or higher in the first polymerization step makes it possible to obtain a PAS having a high melt viscosity in high yield even with a shorter polymerization time. Furthermore, when the amount of the alkali metal hydroxide is 0.75 mol or greater relative to 1 mol of the charged sulfur source in the preparation step, the period of time in which the polymerization reaction can be performed on condition that the pH of the reaction mixture is 11 or more in the first polymerization step is less likely to be too short, and thus the molecular weight of the prepolymer can be sufficiently increased, and the PAS having a high melt viscosity tends to be obtained in high yield.

Note that the number of moles of the alkali metal hydroxide is calculated based on the number of moles of the alkali metal hydroxide added in the preparation step. In the case where the dehydration step is performed, the number of moles of the alkali metal hydroxide is calculated based on the number of moles of the alkali metal hydroxide added in the dehydration step and the number of moles of the alkali metal hydroxide generated due to generated hydrogen sulfide in the dehydration step. When the sulfur source contains an alkali metal sulfide, the number of moles of the alkali metal hydroxide per 1 mol of the sulfur source (charged sulfur source) is calculated in a manner that the number of moles of the alkali metal sulfide is included. When the sulfur source contains hydrogen sulfide, the number of moles of the alkali metal hydroxide per 1 mol of the sulfur source (charged sulfur source) is calculated in a manner that the number of moles of the generated alkali metal sulfide is included. However, the number of moles of the alkali metal hydroxide added for other purposes, such as the number of moles of the alkali metal hydroxide consumed in a reaction such as neutralization in the case where the organic carboxylic acid metal salt is used in a form of a combination of an organic carboxylic acid and an alkali metal hydroxide as a polymerization aid or a phase separation agent, is not included in the number of moles of the alkali metal hydroxide per 1 mol of the sulfur source (charged sulfur source). Furthermore, for example, in the case where at least one acid selected from the group consisting of inorganic acids and organic acids is used for a reason, the number of moles of the alkali metal hydroxide required to neutralize the at least one type of acid is not included in the number of moles of the alkali metal hydroxide per 1 mol of the sulfur source (charged sulfur source).

In the case where the dehydration step is performed, as necessary, in the preparation step, an alkali metal hydroxide and water can be added to the mixture remaining in the system after the dehydration step. In particular, the alkali metal hydroxide is added taking the amount of the hydrogen sulfide generated during the dehydration and the amount of the alkali metal hydroxide generated during the dehydration into account.

In the prepared mixture, the used amount of each of the organic polar solvent and the dihalo aromatic compound is set to be, for example, in a range specified in the description of the polymerizing step below, relative to 1 mol of the charged amount of the sulfur source.

The pH of the prepared mixture is not particularly limited but is preferably from 12.6 to 14, and more preferably from 12.7 to 13.9. The pH of the prepared mixture may be a predetermined value obtained by adjusting the proportion of each of the components such as alkali metal hydroxide. When the pH of the prepared mixture is within the range described above, the time for the polymerization reaction on condition that the pH of the reaction mixture is 11 or more in the first polymerization step is not too short, allowing the molecular weight of the prepolymer to sufficiently increase, and thus the PAS having a high melt viscosity can be obtained in high yield.

### First Polymerization Step

The first polymerization step is a step of performing a polymerization reaction by heating the prepared mixture to produce a reaction mixture containing a prepolymer. In the first polymerization step, the polymerization reaction is performed on condition that the pH of the reaction mixture is 11 or more until a conversion ratio of the dihalo aromatic compound being 50 mol % or greater. A combination of performing the polymerization reaction on condition that the pH of a reaction mixture is 11 or higher until a conversion ratio of the dihalo aromatic compound reaches 50 mol % or greater in the first polymerization step and allowing the amount of the alkali metal hydroxide to be less than an equimolar amount relative to the charged sulfur source in the preparation step makes it possible to obtain a PAS having a high melt viscosity in high yield even with a shorter polymerization time. In the first polymerization step, the polymerization reaction is performed in the reaction system in which a polymer to be produced is uniformly dissolved in the organic polar solvent. In the present specification, a reaction mixture means a mixture containing a reaction product generated by the above-mentioned polymerization reaction, and starts to be generated simultaneously with the initiation of the polymerization reaction.

The temperature at which the prepared mixture is heated in the first polymerization step is preferably from 170 to 260° C., more preferably from 180 to 240° C., and even more preferably from 220 to 230° C., from the perspectives of suppression of side reactions and decomposition reactions and tendency to obtain the PAS having a high melt viscosity in high yield even with a shorter polymerization time.

In the first polymerization step, the dihalo aromatic compound conversion ratio is preferably from 50 to 98 mol %, more preferably from 60 to 97 mol %, even more preferably from 65 to 96 mol %, and particularly preferably from 70 to 95 mol %. The conversion ratio of the dihalo aromatic compound can be calculated by determining the amount of the dihalo aromatic compound remaining in the reaction mixture by gas chromatography and then performing a calculation based on the remaining amount of the dihalo aromatic compound, the prepared amount of the dihalo aromatic compound, and the prepared amount of the sulfur source.

In the first polymerization step, together with the second polymerization step, the polymerization reaction may be performed in batches or continuously. For example, the polymerization reaction can be performed continuously by at least supplying the organic polar solvent, the sulfur source, and the dihalo aromatic compound; producing a PAS by polymerizing the sulfur source and the dihalo aromatic compound in the organic polar solvent; and recovering the reaction mixture containing the PAS simultaneously.

The amount of the organic polar solvent to be used is preferably from 1 to 30 mol, and more preferably from 3 to 15 mol, relative to 1 mol of the sulfur source from the perspective of, for example, efficiency of the polymerization reaction.

The amount of the dihalo aromatic compound to be used is preferably from 0.90 to 1.50 mol, more preferably from 0.92 to 1.10 mol, and even more preferably from 0.95 to 1.05 mol, relative to 1 mol of the charged amount of the sulfur source. When the amount to be used is in the range described above, decomposition reactions are less likely to occur, a stable polymerization reaction can be easily performed, and a high-molecular weight polymer tends to be produced.

The pH of the reaction mixture in the first polymerization step (including the pH of the reaction mixture at the completion of the first polymerization step; hereinafter, the same applies) is 11 or higher, preferably from 11 to 12, and more preferably from 11.3 to 11.8. By setting the pH of the first polymerization step to be within the range described above, it is possible to suppress side reactions occurred due to decrease in pH of the reaction mixture caused by setting the amount of the alkali metal hydroxide to be less than the equimolar amount during the preparation step. That is, it is possible to suppress reduction in the melt viscosity caused by inhibition of the elongation of the molecular chain by byproducts generated by side reactions.

### Second Polymerization Step

The second polymerization step is a step for continuing the polymerization reaction by adding an additional alkali metal hydroxide in the reaction mixture after the first polymerization step. The second polymerization step can further increase the degree of polymerization of the polymer. In the second polymerization step, the amount of the additional alkali metal hydroxide is from 0.09 mol to 0.2 mol relative to 1 mol of the sulfur source. When the amount of the additional alkali metal hydroxide is not within the range described above, formation of byproducts may not be suppressed, impurities may increase, and it may make the stable supply of a PAS having a high melt viscosity difficult.

The heating temperature in the second polymerization step is preferably from 245 to 290° C., and more preferably from 250 to 270° C. The heating temperature may be maintained at a fixed temperature or may be increased or decreased stepwise as necessary. The temperature is preferably maintained at a fixed temperature from the perspective of controlling the polymerization reaction. The polymerization reaction time in the second polymerization step is typically in a range of 10 minutes to 72 hours, and preferably from 30 minutes to 48 hours.

In the second polymerization step, the amount of the additional alkali metal hydroxide is preferably from 0.10 to 0.20 mol, more preferably from 0.09 to 0.19 mol, and even more preferably from 0.08 to 0.17 mol, per 1 mol of the sulfur source. When the amount of the additional alkali metal hydroxide is within the range described above, in the second polymerization step, the total amount of the alkali metal hydroxide per 1 mol of the sulfur source tends to be sufficient, and the PAS having a desired degree of polymerization tends to be obtained. Note that the total amount of the alkali metal hydroxide is the total of the amount of the alkali metal hydroxide present in the prepared mixture and the amount of the alkali metal hydroxide added in the second polymerization step.

In the second polymerization step, the phase-separated polymerization, in which the polymerization reaction is continued on condition that a concentrated polymer phase and a dilute polymer phase are phase-separated in a reaction system, is preferably performed in the presence of a phase separation agent. Specifically, adding a phase separation agent allows the polymerization reaction system to be phase-separated into the concentrated polymer phase (phase mainly containing a dissolved PAS) and the dilute polymer phase (phase mainly containing an organic amide solvent). The phase separation agent may be added at the beginning of the second polymerization step, or the phase separation agent may be added during the second polymerization step to cause the phase separation on the way. Note that, although the phase separation agent may be present not only in the second polymerization step, the phase separation agent is preferably used in the second polymerization step.

As the phase separation agent, at least one type selected from the group consisting of organic carboxylic acid metal salts, organic sulfonic acid metal salts, alkali metal halides, alkaline earth metal halides, alkaline earth metal salts of aromatic carboxylic acids, phosphoric acid alkali metal salts, alcohols, paraffin hydrocarbons, and water can be used. Among these, water is preferable because of low cost and ease in post-treatment. Furthermore, a combination of the organic carboxylic acid salt and water is also preferable. The salts may be in forms obtained by separately adding corresponding acids and bases.

The amount of the phase separation agent to be used varies depending on the type of compound to be used, and the amount is typically in a range of 0.01 to 20 mol per 1 kg of the organic amide solvent. In particular, in the second polymerization step, a method, in which water as the phase separation agent is added in a manner that the water content in the reaction system is more than 4 mol but 20 mol or less per 1 kg of the organic amide solvent, is preferably employed. When water is added as the phase separation agent in the second polymerization step, the water is preferably added in a manner that the water content in the reaction system is more preferably from 4.1 to 14 mol, and particularly preferably from 4.2 to 10 mol, per 1 kg of the organic amide solvent.

### Cooling Step

The cooling step is a step of cooling the reaction mixture after the second polymerization step. Specific operations in the cooling step are as described in JP 6062924 B, for example.

Post-Treatment Steps (such as Separation Step, Washing Step, Recovery Step)

In the method of producing a PAS according to the present embodiment, the post-treatment steps after the polymerization reaction can be performed by common methods, such as the method described in JP 2016-056232 A.

### Obtained PAS

The PAS obtained by the method of producing a PAS of the present embodiment has a melt viscosity measured at a temperature of 310° C. and a shear rate of 1216 sec⁻¹ preferably from 1 to 3000 Pa·s, more preferably from 10 to 1000 Pa·s, even more preferably from 50 to 500 Pa·s, and particularly preferably from 110 to 250 Pa·s. Note that the melt viscosity of the PAS can be measured at the temperature of 310° C. and the shear rate of 1216 sec⁻¹, by using approximately 20 g of a dry polymer and using a capilograph.

Note that the melt viscosity described above can be adjusted by appropriately selecting the used amount of each of the dihalo aromatic compound relative to the sulfur source, the organic polar solvent, the alkali metal hydroxide, and, in some cases, the phase separation agent as well as the polymerization temperature, and the polymerization time. Typically, when the polymerization temperature is increased, the conversion ratio of the dihalo aromatic compound is increased, and the polymerization time required to reach the target conversion ratio becomes shorter; however, the amount of byproducts is increased, the byproducts react with molecular chain terminals to make it difficult to elongate the molecular chain, and thus a PAS having a high melt viscosity is less likely to be obtained. Furthermore, to obtain a PAS having a high melt viscosity, although the polymerization time becomes longer, the first polymerization step needs to be performed to a predetermined conversion ratio while the polymerization temperature is lowered to suppress side reactions. Therefore, the polymerization reaction temperature and time are decided corresponding to the target melt viscosity, for example, from the economic standpoint. Specifically, for example, in the case where the temperature of the polymerization reaction in the first polymerization step is from 240 to 260° C., by setting the time of the polymerization reaction counted from the point when the temperature of the polymerization reaction reached 220° C. to 0.5 to 2 hours, a PAS having a melt viscosity from 5 to 80 can be obtained. Furthermore, in the case where the temperature of the polymerization reaction in the first polymerization step is from 220 to 230° C., suppression of side reactions is further facilitated and, by setting the time of the polymerization reaction counted from the point when the temperature of the polymerization reaction reached 220° C. to 1.5 to 6 hours, a PAS having a melt viscosity from 80 to 500 can be obtained. In order to obtain a PAS having a high melt viscosity, side reactions in the first polymerization step are preferably suppressed.

The PAS obtained by the method of producing a PAS of the present embodiment can be formed into various injection molded products or extrusion molded products, such as sheets, films, fibers, and pipes, as is or after undergoing oxidative-crosslinking, alone or by blending with various inorganic fillers, fibrous fillers, and various synthetic resins, as desired.

In the method of producing a PAS of the present embodiment, the PAS is not particularly limited and is preferably a PPS.

The present invention is not limited to the embodiments described above, and various modifications are possible within the scope indicated in the claims. Embodiments obtained by appropriately combining the technical means disclosed by the embodiments are also included in the technical scope of the present invention. In addition, all of the documents described in the present specification are herein incorporated by reference.

### EXAMPLES

The present invention will be more specifically described hereinafter with reference to examples and comparative examples. Note that the present invention is not limited to these examples. The measurement methods for characteristics and physical properties are as follows.

### (1) Yield of Polymer

As the yield of the PAS polymer (hereinafter, also simply referred to as “polymer”), a proportion of the polymer mass actually recovered relative to a reference value, which was the polymer mass (theoretical amount) obtained by assuming that all the effective sulfur source present in the reactor after the dehydration step were converted to the polymer, was calculated and used as the yield of the polymer (unit: mass %).

### (2) Melt Viscosity

The melt viscosity was measured by using approximately 20 g of dried polymer and the Capirograph 1-C, available from Toyo Seiki Seisaku-sho, Ltd. At this time, a flat die having a diameter of 1 mm and a length of 10 mm was used as the capillary, and the temperature was set to 310° C. The polymer sample was introduced into the instrument, and after the sample was held for 5 minutes, the melt viscosity at a shear rate of 1216 sec⁻¹ was measured (unit: Pa·s).

### (3) pH of Reaction Mixture

The reaction mixture at the completion of the first polymerization step was diluted 10 times using purified water (available from Kanto Chemical Co., Inc.) to obtain a dilution, and then pH of the dilution measured at room temperature using a pH meter was used as the pH of the reaction mixture. Furthermore, as an estimate of the pH change, the pH of the reaction mixture at 0.5 hours after the temperature reached at 220° C. in the first polymerization step was determined by the same method as described above.

### (4) Amount of Sulfur Source

For the sodium hydrosulfide (NaSH) and sodium sulfide (Na₂S) in the sulfur source aqueous solution, the total amount of the sulfur content was determined by iodimetry, and the amount of NaSH was determined by neutralization titration. The value obtained by subtracting the amount of NaSH from the total amount of the sulfur content was used as the amount of Na₂S.

### Example 1

### 1. Dehydration Step:

As the sulfur source, 2003.2 g of sodium hydrosulfide (NaSH) aqueous solution having the analytical value by iodimetry of 62.01 mass % was used. The analytical value of NaSH by neutralization titration of this sulfur source was 60.91 mass % (22.16 mol), and 0.39 mol of sodium sulfide (Na₂S) was contained therein. The sodium hydrosulfide aqueous solution described above and 1009.3 g of 73.56 mass % sodium hydroxide (NaOH) aqueous solution were charged in a 20 L autoclave (hereinafter, also referred to as “reactor”) made of titanium together with 6000.8 g of N-methyl-pyrrolidone (NMP). When the sulfur source formed from the sodium hydrosulfide and the sodium sulfide is denoted as “S”, NaOH/S before the dehydration was 0.85 (mole/mole; hereinafter, also referred to as “mol/mol”). After the inside of the reactor was purged with nitrogen gas, the temperature was gradually raised to 200° C. over approximately two hours while the contents in the reactor were being stirred, thereby 943.0 g of water and 710.8 g of NMP were distilled. At this time, 0.47 mol of hydrogen sulfide (H₂S) was volatilized. Therefore, the effective S amount (i.e. amount of “charged sulfur source”) in the reactor after the dehydration step was 21.69 mol. The volatilized H₂S content corresponded to 2.13 mol % relative to the sulfur source charged in the reactor.

### 2. Preparation Step:

After the dehydration step, the reactor was cooled to a temperature of 170° C., 3219.8 g of p-dichlorobenzene (hereinafter, also referred to as “pDCB”; pDCB/effective S=1.010 (mol/mol); note that the value of “mol/mol” was calculated to three decimal places; hereinafter the same), 2842.4 g of NMP (NMP/effective S=375 (g/mol)), and 134.7 g of water were added. Furthermore, 3.7 g of NaOH with a purity of 97 mass % was added in a manner that NaOH in reactor/effective S=0.900 (mol/mol) to obtain a prepared mixture (total water content in reactor/NMP=3.7 (mol/kg)).

### 3. Polymerization Step:

The temperature was increased from 183° C. to 220° C. over 1.0 hour while the prepared mixture was stirred by rotating the stirrer provided in the reactor. The temperature was maintained for 1.0 hour, and then increased to 230° C. over 30 minutes to perform a polymerization reaction for 1.0 hour (first polymerization step). The pDCB conversion ratio was 86.4 mol %. Thereafter, 441.5 g of water and 134.1 g of NaOH were introduced under pressure (total water content in reactor/NMP=7.0 (mol/kg); total NaOH/effective S=1.050 (mol/mol)), and then the temperature was raised to 260° C. to perform a polymerization reaction for 5.0 hours as the phase-separated polymerization (second polymerization step). The reaction mixture was cooled to room temperature following the completion of the polymerization reaction.

### 4. Post-Treatment Step:

After the reaction mixture was cooled to room temperature after the completion of the polymerization reaction as described above, the reaction mixture was passed through a 100-mesh screen (sieve opening: 150 μm) to sieve the polymer (particulate polymer). The separated polymer was washed three times with acetone, then washed three times with water, washed with 0.18 mass % acetic acid, and further washed four times with water to obtain a washed polymer. The washed polymer was dried at a temperature of 105° C. for 13 hours. The yield of the particulate polymer (passed through 100-mesh) obtained as described above was 86.2 mass %. The characteristics of the polymer are shown in Table 1.

### Example 2

1. Dehydration step:

As the sulfur source, 2003.8 g of NaSH aqueous solution having the analytical value by iodimetry of 62.01 mass % was used. The analytical value of NaSH by neutralization titration of this sulfur source was 60.91 mass % (22.77 mol), and 0.39 mol of Na₂S was contained therein. The NaSH aqueous solution described above and 1011.7 g of 73.56 mass % NaOH aqueous solution were introduced in a reactor together with 6009.7 g of NMP. The NaOH/S before the dehydration was 0.85 (mol/mol). After the inside of the reactor was purged with nitrogen gas, the temperature was gradually raised to 200° C. over approximately two hours while the contents in the reactor were being stirred, thereby 954.7 g of water and 643.4 g of NMP were distilled. At this time, 0.49 mol of H₂S was volatilized. Therefore, the effective S amount in the reactor after the dehydration step was 21.68 mol. The volatilized H₂S content corresponded to 2.19 mol % relative to the sulfur source charged in the reactor.

### 2. Preparation Step:

After the dehydration step, the reactor was cooled to a temperature of 170° C., and 3206.0 g of pDCB (pDCB/effective S=1.006 (mol/mol)), 2763.6 g of NMP (NMP/effective S=375 (g/mol)), and 145.7 g of water were added. Furthermore, 1.0 g of NaOH with a purity of 97 mass % was added in a manner that NaOH in reactor/effective S=0.900 (mol/mol) to obtain a prepared mixture (total water content in reactor/NMP=3.7 (mol/kg)).

### 3. Polymerization Step:

The temperature was increased from 183° C. to 220° C. over 1.0 hour while the prepared mixture was stirred by rotating the stirrer provided in the reactor. The temperature was maintained for 1.0 hour, and then increased to 230° C. over 30 minutes to perform a polymerization reaction for 0.5 hours (first polymerization step). The pDCB conversion ratio was 81.1 mol %. Thereafter, 441.4 g of water and 132.3 g of NaOH were introduced under pressure (total water content in reactor/NMP=7.0 (mol/kg); total NaOH/effective S=1.048 (mol/mol)), and then the temperature was raised to 260° C. to perform the reaction for 5.0 hours as the phase-separated polymerization (second polymerization step). The reaction mixture was cooled to room temperature following the completion of the polymerization reaction.

### 4. Post-Treatment Step:

After the completion of the polymerization reaction, the washed polymer was obtained in the same manner as in Example 1. The washed polymer was dried at a temperature of 105° C. for 13 hours. The yield of the particulate polymer (passed through 100-mesh) obtained as described above was 87.3 mass %. The characteristics of the polymer are shown in Table 1.

### Example 3

### 1. Dehydration Step:

As the sulfur source, 2005.4 g of NaSH aqueous solution having the analytical value by iodimetry of 62.01 mass % was used. The analytical value of NaSH by neutralization titration of this sulfur source was 60.91 mass % (22.18 mol), and 0.39 mol of Na₂S was contained therein. The NaSH aqueous solution described above and 1071.6 g of 73.56 mass % NaOH aqueous solution were introduced in a reactor together with 6006.5 g of NMP. The NaOH/S before the dehydration was 0.90 (mol/mol). After the inside of the reactor was purged with nitrogen gas, the temperature was gradually raised to 200° C. over approximately two hours while the contents in the reactor were being stirred, thereby 971.1 g of water and 615.2 g of NMP were distilled. At this time, 0.44 mol of H₂S was volatilized. Therefore, the effective S amount in the reactor after the dehydration step was 21.74 mol. The volatilized H₂S content corresponded to 1.99 mol % relative to the sulfur source charged in the reactor.

### 2. Preparation Step:

After the dehydration step, the reactor was cooled to a temperature of 170° C., and 3237.3 g of pDCB (pDCB/effective S=1.013 (mol/mol)), 2761.1 g of NMP (NMP/effective S=375 (g/mol)), and 145.5 g of water were added. Furthermore, 4.5 g of NaOH with a purity of 97 mass % was added in a manner that NaOH in reactor/effective S=0.950 (mol/mol) to obtain a prepared mixture (total water content in reactor/NMP=3.9 (mol/kg)).

### 3. Polymerization Step:

The first polymerization step was performed in the same manner as in Example 1. The pDCB conversion ratio was 85.7 mol %. Thereafter, 442.6 g of water and 94.1 g of NaOH were introduced under pressure (total water content in reactor/NMP=7.0 (mol/kg); total NaOH/effective S=1.055 (mol/mol)), and then the temperature was raised to 260° C. to perform the reaction for 5.0 hours as the phase-separated polymerization (second polymerization step). The reaction mixture was cooled to room temperature following the completion of the polymerization reaction.

### 4. Post-Treatment Step:

After the completion of the polymerization reaction, the washed polymer was obtained in the same manner as in Example 1. The washed polymer was dried at a temperature of 105° C. for 13 hours. The yield of the particulate polymer (passed through 100-mesh) obtained as described above was 86.8 mass %. The characteristics of the polymer are shown in Table 1.

### Example 4

### 1. Dehydration Step:

As the sulfur source, 2005.7 g of NaSH aqueous solution having the analytical value by iodimetry of 61.55 mass % was used. The analytical value of NaSH by neutralization titration of this sulfur source was 60.62 mass % (22.02 mol), and 0.33 mol of Na₂S was contained therein. The NaSH aqueous solution described above and 1071.1 g of 73.36 mass % NaOH aqueous solution were introduced in a reactor together with 6011.8 g of NMP. The NaOH/S before the dehydration was 0.91 (mol/mol). After the inside of the reactor was purged with nitrogen gas, the temperature was gradually raised to 200° C. over approximately two hours while the contents in the reactor were being stirred, thereby 954.0 g of water and 662.6 g of NMP were distilled. At this time, 0.46 mol of H₂S was volatilized. Therefore, the effective S amount in the reactor after the dehydration step was 21.56 mol. The volatilized H₂S content corresponded to 2.08 mol % relative to the sulfur source charged in the reactor.

### 2. Preparation Step:

After the dehydration step, the reactor was cooled to a temperature of 170° C., and 3214.0 g of pDCB (pDCB/effective S=1.014 (mol/mol)), 2736.6 g of NMP (NMP/effective S=375 (g/mol)), and 113.3 g of water were added. Furthermore, 1.9 g of NaOH with a purity of 97 mass % was added in a manner that NaOH in reactor/effective S=0.950 (mol/mol) to obtain a prepared mixture (total water content in reactor/NMP=3.9 (mol/kg)).

### 3. Polymerization Step:

The first polymerization step was performed in the same manner as in Example 2. The pDCB conversion ratio was 79.4 mol %. Thereafter, 439.0 g of water and 93.4 g of NaOH were introduced under pressure (total water content in reactor/NMP=7.0 (mol/kg); total NaOH/effective S=1.055 (mol/mol)), and then the temperature was raised to 260° C. to perform the reaction for 5.0 hours as the phase-separated polymerization (second polymerization step). The reaction mixture was cooled to room temperature following the completion of the polymerization reaction.

### 4. Post-treatment Step:

After the completion of the polymerization reaction, the washed polymer was obtained in the same manner as in Example 1. The washed polymer was dried at a temperature of 105° C. for 13 hours. The yield of the particulate polymer (passed through 100-mesh) obtained as described above was 85.4 mass %. The characteristics of the polymer are shown in Table 1.

### Comparative Example 1

### 1. Dehydration Step:

As the sulfur source, 2003.6 g of NaSH aqueous solution having the analytical value by iodimetry of 62.30 mass % was used. The analytical value of NaSH by neutralization titration of this sulfur source was 61.19 mass % (22.26 mol), and 0.40 mol of Na₂S was contained therein. The NaSH aqueous solution described above and 1011.7 g of 73.46 mass % NaOH aqueous solution were introduced in a reactor together with 6006.8 g of NMP. The NaOH/S before the dehydration was 0.85 (mol/mol). After the inside of the reactor was purged with nitrogen gas, the temperature was gradually raised to 200° C. over approximately two hours while the contents in the reactor were being stirred, thereby 932.3 g of water and 642.9 g of NMP were distilled. At this time, 0.47 mol of H₂S was volatilized. Therefore, the effective S amount in the reactor after the dehydration step was 21.80 mol. The volatilized H₂S content corresponded to 2.10 mol % relative to the sulfur source charged in the reactor.

### 2. Preparation Step:

After the dehydration step, the reactor was cooled to a temperature of 170° C., and 3236.6 g of pDCB (pDCB/effective S=1.010 (mol/mol)), 2810.9 g of NMP (NMP/effective S=375 (g/mol)), and 129.0 g of water were added. Furthermore, 7.1 g of NaOH with a purity of 97 mass % was added in a manner that NaOH in reactor/effective S=0.900 (mol/mol) to obtain a prepared mixture (total water content in reactor/NMP=3.7 (mol/kg)).

### 3. Polymerization Step:

The first polymerization step was performed in the same manner as in Example 1, in which the temperature was increased from 183° C. to 220° C. over 1.0 hour while the prepared mixture was stirred by rotating the stirrer provided in the reactor, then maintained for 1.0 hour, and then increased to 230° C. over 30 minutes to perform a polymerization reaction for 1.5 hours (first polymerization step). The pDCB conversion ratio was 90.1 mol %. Thereafter, 443.8 g of water and 143.8 g of NaOH were introduced under pressure (total water content in reactor/NMP=7.0 (mol/kg); total NaOH/effective S=1.060 (mol/mol)), and then the temperature was raised to 260° C. to perform the reaction for 5.0 hours as the phase-separated polymerization (second polymerization step). The reaction mixture was cooled to room temperature following the completion of the polymerization reaction.

### 4. Post-Treatment Step:

After the completion of the polymerization reaction, the washed polymer was obtained in the same manner as in Example 1. The washed polymer was dried at a temperature of 105° C. for 13 hours. The yield of the particulate polymer (passed through 100-mesh) obtained as described above was 85.1 mass %. The characteristics of the polymer are shown in Table 1.

### Comparative Example 2

### 1. Dehydration Step:

As the sulfur source, 2003.0 g of NaSH aqueous solution having the analytical value by iodimetry of 62.01 mass % was used. The analytical value of NaSH by neutralization titration of this sulfur source was 60.91 mass % (22.16 mol), and 0.39 mol of Na₂S was contained therein. The NaSH aqueous solution described above and 1132.6 g of 73.56 mass % NaOH aqueous solution were introduced in a reactor together with 6002.5 g of NMP. The NaOH/S before the dehydration was 0.96 (mol/mol). After the inside of the reactor was purged with nitrogen gas, the temperature was gradually raised to 200° C. over approximately two hours while the contents in the reactor were being stirred, thereby 973.5 g of water and 641.5 g of NMP were distilled. At this time, 0.43 mol of H₂S was volatilized. Therefore, the effective S amount in the reactor after the dehydration step was 21.73 mol. The volatilized H₂S content corresponded to 1.94 mol % relative to the sulfur source charged in the reactor.

### 2. Preparation Step:

After the dehydration step, the reactor was cooled to a temperature of 170° C., and 3257.6 g of pDCB (pDCB/effective S=1.020 (mol/mol)), 2786.3 g of NMP (NMP/effective S=375 (g/mol)), and 132.2 g of water were added. Furthermore, 3.0 g of NaOH with a purity of 97 mass % was added in a manner that NaOH in reactor/effective S=1.000 (mol/mol) to obtain a prepared mixture (total water content in reactor/NMP=4.0 (mol/kg)).

### 3. Polymerization Step:

The first polymerization step was performed in the same manner as in Comparative Example 1. The pDCB conversion ratio was 89.7 mol %. Thereafter, 442.3 g of water and 58.2 g of NaOH were introduced under pressure (total water content in reactor/NMP=7.0 (mol/kg); total NaOH/effective S=1.065 (mol/mol)), and then the temperature was raised to 260° C. to perform the reaction for 5.0 hours as the phase-separated polymerization (second polymerization step). The reaction mixture was cooled to room temperature following the completion of the polymerization reaction.

### 4. Post-Treatment Step:

After the completion of the polymerization reaction, the washed polymer was obtained in the same manner as in Example 1. The washed polymer was dried at a temperature of 105° C. for 13 hours. The yield of the particulate polymer (passed through 100-mesh) obtained as described above was 88.1 mass %. The characteristics of the polymer are shown in Table 1.

### Comparative Example 3

### 1. Dehydration Step:

As the sulfur source, 2003.2 g of NaSH aqueous solution having the analytical value by iodimetry of 62.01 mass % was used. The analytical value of NaSH by neutralization titration of this sulfur source was 60.91 mass % (22.16 mol), and 0.39 mol of Na₂S was contained therein. The NaSH aqueous solution described above and 1133.0 g of 73.56 mass % NaOH aqueous solution were introduced in a reactor together with 6003.7 g of NMP. The NaOH/S before the dehydration was 0.96 (mol/mol). After the inside of the reactor was purged with nitrogen gas, the temperature was gradually raised to 200° C. over approximately two hours while the contents in the reactor were being stirred, thereby 989.7 g of water and 643.6 g of NMP were distilled. At this time, 0.44 mol of H₂S was volatilized. Therefore, the effective S amount in the reactor after the dehydration step was 21.72 mol. The volatilized H₂S content corresponded to 1.97 mol % relative to the sulfur source charged in the reactor.

### 2. Preparation Step:

After the dehydration step, the reactor was cooled to a temperature of 170° C., and 3234.5 g of pDCB (pDCB/effective S=1.013 (mol/mol)), 2785.1 g of NMP (NMP/effective S=375 (g/mol)), and 148.4 g of water were added. Furthermore, 2.1 g of NaOH with a purity of 97 mass % was added in a manner that NaOH in reactor/effective S=1.000 (mol/mol) to obtain a prepared mixture (total water content in reactor/NMP=4.0 (mol/kg)).

### 3. Polymerization Step:

The first polymerization step was performed in the same manner as in Example 1. The pDCB conversion ratio was 85.8 mol %. Thereafter, 442.2 g of water and 53.7 g of NaOH were introduced under pressure (total water content in reactor/NMP=7.0 (mol/kg); total NaOH/effective S=1.060 (mol/mol)), and then the temperature was raised to 260° C. to perform the reaction for 5.0 hours as the phase-separated polymerization (second polymerization step). The reaction mixture was cooled to room temperature following the completion of the polymerization reaction.

### 4. Post-Treatment Step:

After the completion of the polymerization reaction, the washed polymer was obtained in the same manner as in Example 1. The washed polymer was dried at a temperature of 105° C. for 13 hours. The yield of the particulate polymer (passed through 100-mesh) obtained as described above was 88.7 mass %. The characteristics of the polymer are shown in Table 1.

### Comparative Example 4

### 1. Dehydration Step:

As the sulfur source, 2004.8 g of NaSH aqueous solution having the analytical value by iodimetry of 62.37 mass % was used. The analytical value of NaSH by neutralization titration of this sulfur source was 61.25 mass % (22.30 mol), and 0.40 mol of Na₂S was contained therein. The NaSH aqueous solution described above and 1014.6 g of 73.65 mass % NaOH aqueous solution were introduced in a reactor together with 6001.6 g of NMP. The NaOH/S before the dehydration was 0.85 (mol/mol). After the inside of the reactor was purged with nitrogen gas, the temperature was gradually raised to 200° C. over approximately two hours while the contents in the reactor were being stirred, thereby 964.8 g of water and 697.3 g of NMP were distilled. At this time, 0.47 mol of H₂S was volatilized. Therefore, the effective S amount in the reactor after the dehydration step was 21.83 mol. The volatilized H₂S content corresponded to 2.13 mol % relative to the sulfur source charged in the reactor.

### 2. Preparation Step:

After the dehydration step, the reactor was cooled to a temperature of 170° C., and 3257.2 g of pDCB (pDCB/effective S=1.015 (mol/mol)), 2882.1 g of NMP (NMP/effective S=375 (g/mol)), and 164.3 g of water were added. Furthermore, 3.6 g of NaOH with a purity of 97 mass% was added in a manner that NaOH in reactor/effective S=0.900 (mol/mol) to obtain a prepared mixture (total water content in reactor/NMP=3.7 (mol/kg)).

### 3. Polymerization Step:

While the prepared mixture was stirred by rotating a stirrer installed in the reactor, the temperature was continuously raised from 183° C. to 260° C. over 2.5 hours to perform the first polymerization step. The pDCB conversion ratio was 83.5 mol %. Thereafter, 444.4 g of water and 148.5 g of NaOH were introduced under pressure (total water content in reactor/NMP=7.0 (mol/kg); total NaOH/effective S=1.065 (mol/mol)), and then the temperature was raised to 260° C. to perform the reaction for 5.0 hours as the phase-separated polymerization (second polymerization step). The reaction mixture was cooled to room temperature following the completion of the polymerization reaction.

### 4. Post-Treatment Step:

After the completion of the polymerization reaction, the washed polymer was obtained in the same manner as in Example 1. The washed polymer was dried at a temperature of 105° C. for 13 hours. The yield of the particulate polymer (passed through 100-mesh) obtained as described above was 87.2 mass %. The characteristics of the polymer are shown in Table 1.

TABLE 1

| | | | | | Compar- | Compar- | Compar- | Compar- |
|---|---|---|---|---|---|---|---|---|
| | Ex- | Ex- | Ex- | Ex- | ative | ative | ative | ative |
| | ample | ample | ample | ample | Example | Example | Example | Example |
| | 1 | 2 | 3 | 4 | 1 | 2 | 3 | 4 |
| First polymerization step | | | | | | | | |
| H₂O/NMP (mol/kg) | 3.7 | 3.7 | 3.9 | 3.9 | 3.7 | 4.0 | 4.0 | 3.7 |
| NaOH/S (mol/mol) | 0.900 | 0.900 | 0.950 | 0.950 | 0.900 | 1.000 | 1.000 | 0.900 |
| Temperature/time (° C./hour) | 220/1.0 | 220/1.0 | 220/1.0 | 220/1.0 | 220/1.0 | 220/1.0 | 220/1.0 | 183→ |
| | 230/1.0 | 230/0.5 | 230/1.0 | 230/0.5 | 230/1.5 | 230/1.5 | 230/1.0 | 260/2.5 |
| Second polymerization step | | | | | | | | |
| H₂O/NMP (mol/kg) | 7.0 | 7.0 | 7.0 | 7.0 | 7.0 | 7.0 | 7.0 | 7.0 |
| NaOH/S (mol/mol) | 1.050 | 1.048 | 1.055 | 1.055 | 1.060 | 1.065 | 1.060 | 1.065 |
| Temperature/time (° C./hour) | 260/5.0 | 260/5.0 | 260/5.0 | 260/5.0 | 260/5.0 | 260/5.0 | 260/5.0 | 260/5.0 |
| pH | | | | | | | | |
| At the time when 30 minutes | 11.98 | 11.98 | 12.00 | 12.00 | 11.98 | 12.01 | 12.01 | 11.82 |
| had passed after reaching 220° C. | | | | | | | | |
| At completion of first | 11.32 | 11.63 | 11.53 | 11.65 | 10.82 | 11.66 | 11.72 | 9.53 |
| polymerization step | | | | | | | | |
| Polymer characteristics | | | | | | | | |
| Melt viscosity (Pa · s) | 131 | 129 | 135 | 124 | 106 | 122 | 89 | 60 |
| Yield of polymer (mass %) | 86.2 | 87.3 | 86.8 | 85.4 | 85.1 | 88.1 | 88.7 | 87.2 |

From the results of Examples 1 to 3 shown in Table 1, it was confirmed that the method of producing a PAS according to an embodiment of the present invention can provide a PAS having a high melt viscosity in high yield in a shorter polymerization time. On the other hand, it was confirmed that a PAS having a high melt viscosity could not be obtained in Comparative Example 1, in which the pH at the completion of the first polymerization step was less than 11. Furthermore, in Comparative Examples 2 and 3 in which the amount of the alkali metal hydroxide in the preparation step was less than an equimolar amount relative to the sulfur source, obtaining a PAS having a high melt viscosity required a longer polymerization time (Comparative Example 2), and if the polymerization is shorter, a PAS having a high melt viscosity could not be obtained (Comparative Example 3).

1. A method of producing a polyarylene sulfide by polymerizing a sulfur source and a dihalo aromatic compound in an organic polar solvent, the method comprising:
a preparation step for preparing a mixture containing an organic polar solvent, a sulfur source, water, a dihalo aromatic compound, and an alkali metal hydroxide;
a first polymerization step for performing a polymerization reaction by heating the mixture to produce a reaction mixture containing a prepolymer; and
a second polymerization step for continuing to perform a polymerization reaction subsequent to the first polymerization by adding an additional alkali metal hydroxide to the reaction mixture;
wherein in the preparation step, an amount of the alkali metal hydroxide is less than an equimolar amount relative to the sulfur source;
wherein in the first polymerization step, the polymerization reaction is performed until a conversion ratio of the dihalo aromatic compound reaches 50 mol % or greater on condition that a pH of the reaction mixture is 11 or higher, and an alkali metal hydroxide is added before the pH of the reaction mixture reaches 11 or lower to initiate the second polymerization step; and
wherein in the second polymerization step, an amount of the additional alkali metal hydroxide is from 0.09 mol to 0.2 mol relative to 1 mol of the sulfur source.

2. The method according to claim 1, wherein a melt viscosity of the polyarylene sulfide measured at a temperature of 310° C. and a shear rate of 1216 sec⁻¹ is from 1 to 3000 Pa·s.

3. The method according to claim 1, wherein, in the preparation step, the amount of the alkali metal hydroxide is 0.75 mol or greater and less than 1 mol relative to 1 mol of the sulfur source.
